(19) United States
(12) Patent Application Publication
(10) Pub. No.: US 2014/0017424 A1
(43) Pub. Date: Jan. 16, 2014

(54) CONTAINER FOR HEAT TREATMENT OF LITHIUM-CONTAINING COMPOUND

(71) Applicants: Yasuta Koike, Tajimi-shi (JP); Takashi Achiha, Kobe-shi (JP); Takahiro Kamiya, Tajimi-shi (JP)

(72) Inventors: Yasuta Koike, Tajimi-shi (JP); Takashi Achiha, Kobe-shi (JP); Takahiro Kamiya, Tajimi-shi (JP)

(73) Assignee: TYK Corporation, Tokyo (JP)

(21) Appl. No.: 14/008,755

(22) PCT Filed: Jun. 28, 2011
(86) PCT No.: PCT/JP11/03667

§ 371 Date: Sep. 30, 2013

(30) Foreign Application Priority Data
Mar. 30, 2011 (JP) 2011-075441

(51) Int. Cl. C04B 35/10

(52) U.S. Cl. CPC C04B 35/10
USPC 428/34.4

(57) ABSTRACT

A container for heat treatment of a positive-electrode active material of a lithium ion battery to hold raw material powder of the positive-electrode active material of the lithium ion battery when the raw material powder is subjected to heat treatment is provided. The heat treatment container contains 60 to 95 mass % of alumina and 10 to 20 mass % of silica, is free from MgO, ZrO₂ and Li compounds, and has a porosity of 10 to 20%. The heat treatment container suppresses a reaction product from contaminating the raw material powder owing to suppressed reactivity with the raw material powder, and is suppressed from being cracked by thermal shock owing to the porosity in the predetermined range.

### TECHNICAL FIELD

The present invention relates to a container for heat treatment of a lithium-containing compound to be used in applying heat treatment to the lithium-containing compound.

### BACKGROUND ART

A variety of compounds, especially inorganic compounds are produced through a heat treatment step. In general, heat treatment is carried out by heating a compound (an inorganic compound or a raw material thereof) to be thermally treated with the compound held by a heat-resistant heat treatment container. The heat treatment container is demanded to be not only heat resistant but also stable against the compound to be thermally treated.

One example of the abovementioned inorganic compounds produced through the heat treatment step is a lithium-containing compound. The lithium-containing compound is used, for example, for a positive-electrode active material of a lithium-ion battery. Examples of the lithium-containing compound include LiMnO₂-based compounds, LiNi_{1/3}CO_{1/3}Mn_{1/3}O₂-based compounds, LiMn₂O₄-based compounds, LiCoO₂-based compounds and LiNiO₂-based compounds.

The positive-electrode active material of the lithium-ion battery (the lithium-containing compound) is produced by firing raw material powder. In general, this heat treatment (firing) of the lithium-containing compound is performed with the raw material powder stored in a container (a saggar) which was produced by firing a material having such a heat-resistant material as alumina, mullite, cordierite and spinel as a main component thereof. The saggar is disclosed, for example, in Japanese Unexamined Patent Publication No. 2009-292704.

A saggar having cordierite as a main component thereof has a high thermal shock resistance. However, since such a saggar has a high reactivity with lithium-containing compounds, there arises a problem that mixing in of a reaction product lowers purity of a lithium-containing compound after subjected to heat treatment. Especially in a case of a positive-electrode active material of a lithium-ion battery, such mixed-in impurities not only cause a decrease in battery performance of a resultant lithium-ion battery but also have a risk of becoming sources of short circuiting.

On the other hand, a saggar having alumina or spinel as a main component thereof has a low reactivity with lithium-containing compounds. However, such a saggar has a high coefficient of thermal expansion and has a problem that a higher content of these components increases occurrence of cracking caused by thermal shock. Therefore, it has been difficult to increase the alumina or spinel content.

Japanese Unexamined Patent Publication No. 2009-292704 describes a saggar comprising spinel, cordierite and mullite. These materials have the aforementioned problems.

### CITATION LIST

### Patent Literature

[PTL 1] Japanese Unexamined Patent Publication No. 2009-292704

### SUMMARY OF INVENTION

### Technical Problem

The present invention has been made in view of the aforementioned actual circumstances. It is an object of the present invention to provide a container for heat treatment of a lithium-containing compound capable of suppressing contamination of the lithium-containing compound and having good thermal shock resistance.

### Solution to Problem

In order to solve the abovementioned problems, the present inventors have conducted further research on containers for heat treatment of lithium-containing compounds, and have reached the present invention.

That is to say, in a container for heat treatment of a lithium-containing compound to hold the lithium-containing compound when the lithium-containing compound is subjected to heat treatment, the container for heat treatment of the lithium-containing compound of the present invention is characterized by containing 60 to 95 mass % of alumina (Al₂O₃) when the total mass of the container is assumed to be 100 mass %, and having a porosity of 10 to 30%.

It is preferred that the container for heat treatment of the lithium-containing compound of the present invention contains 5 to 30 mass % of silica (SiO₂) when the total mass of the container is assumed to be 100 mass %.

It is preferred that the container for heat treatment of the lithium-containing compound of the present invention is formed of alumina and mullite.

### Advantageous Effects of the Invention

Upon containing as much alumina as 60 to 95 mass %, the container for heat treatment of the lithium-containing compound of the present invention is suppressed from reacting with the lithium-containing compound. In addition, upon having a porosity of 10 to 30%, the container is suppressed from being cracked by thermal shock.

That is to say, the container for heat treatment of the lithium-containing compound of the present invention is a container capable of suppressing a reaction product from contaminating the lithium-containing compound owing to suppressed reactivity with the lithium-containing compound, and at the same time suppressed from being cracked (damaged) by thermal shock.

### MODES FOR CARRYING OUT THE INVENTION

### Container for Heat Treatment of Lithium-Containing Compound

The container for heat treatment of the lithium-containing compound of the present invention (hereinafter, referred to as the heat treatment container of the present invention) is a container for heat treatment of a lithium-containing compound to hold the lithium-containing compound when the lithium-containing compound is subjected to heat treatment. The lithium-containing compound to be thermally treated in the heat treatment container of the present invention only has to be a compound which contains lithium (Li) in its chemical formula and, besides, can be a mixture with a lithium-containing compound.

The heat treatment container of the present invention contains a material (alumina) having low reactivity with the lithium-containing compound to be subjected to heat treatment (the compound to be thermally treated) in a large amount (as a main component thereof), and has been controlled to have a porosity of 10 to 30%.

Moreover, the heat treatment container of the present invention contains 60 to 95 mass % of alumina (Al₂O₃) when the total mass of the container is assumed to be 100 mass %.

Alumina, which is a main component of the heat treatment container of the present invention, is a material having a low reactivity with the lithium-containing compound. That is to say, upon containing a large amount of alumina, the heat treatment container of the present invention can suppress the lithium-containing compound from reacting with the heat treatment container and yielding a reaction product when the lithium-containing compound is subjected to heat treatment. As a result, the lithium-containing compound subjected to heat treatment is suppressed from being contaminated by the reaction product.

The heat treatment container of the present invention contains 60 to 95 mass % of alumina when the total mass of the container is assumed to be 100 mass %. Upon containing 60 to 95 mass % of alumina, the container is suppressed from reacting with the lithium-containing compound and improves in thermal shock resistance. When the alumina content is less than 60 mass %, the container easily reacts with the lithium-containing compound. When the alumina content is more than 95 mass %, the heat treatment container is liable to crack. Amore preferred alumina content range is 70 to 90 mass %.

The heat treatment container of the present invention has a porosity of 10 to 30%. Upon having a porosity in this range, the heat treatment container improves in thermal shock resistance. When the porosity is below this range, the container is liable to be cracked by heat treatment. When the porosity is above this range, lithium penetration may cause peeling off. A more preferred porosity range is 15 to 25%.

It is preferred that the heat treatment container of the present invention contains 5 to 30 mass % of silica (SiO₂) when the total mass of the container is assumed to be 100 mass %. Silica is a compound which exhibits an effect of improving thermal shock resistance of the heat treatment container. Moreover, since silica has a reactivity with the lithium-containing compound to be thermally treated, a smaller silica content is more preferred. When the silica content is below this range, an alumina content relatively increases, which causes a decrease in thermal shock resistance and cracking (damage) of the heat treatment container. On the other hand, when the silica content is above this range, the container easily reacts with the lithium-containing compound and a reaction product thereof is liable to contaminate the lithium-containing compound. Therefore, upon containing silica in an amount in this range, the lithium-containing compound can be suppressed from being contaminated while the heat treatment container improves in thermal shock resistance. A more preferred silica content range is 10 to 20 mass %.

It is preferred that the heat treatment container of the present invention is formed of alumina and mullite. Alumina is a compound represented by a chemical formula Al₂O₃. Mullite is a compound of alumina (Al₂O₃) and silica (SiO₂), (aluminosilicate), and has a compositional formula Al₆O₁₃Si₂. That is to say, upon being formed of alumina and mullite, the container is free from a material (a compound) which easily reacts with the lithium-containing compound, so the lithium-containing compound can be suppressed from being contaminated while the heat treatment container of the present invention improves in thermal shock resistance. In the present invention, it is preferred that the container is free from a material (a compound) which easily reacts with the lithium-containing compound. An example of such a material is magnesia (MgO). Here, being formed of alumina and mullite means not only being formed of alumina and mullite alone but also being formed so as to have alumina and mullite as main components thereof. Furthermore, in the present invention, the container can contain inevitable impurities.

It is preferred that the heat treatment container of the present invention is formed of alumina and mullite alone. Upon being formed of alumina and mullite alone, the container is free from other inorganic elements which have reactivity with the lithium-containing compound, so the lithium-containing compound can be suppressed from being contaminated while the heat treatment container of the present invention improves in thermal shock resistance. For example, cordierite, which is a main component material of conventional saggars, contains magnesia, and this magnesia reacts with the lithium-containing compound and yields a reaction product.

In the heat treatment container of the present invention, heat treatment applied to the lithium-containing compound is not limited to a treatment of heating the lithium-containing compound with the lithium-containing compound held by the heat treatment container of the present invention, but includes a heating (firing) treatment for generating the lithium-containing compound. That is to say, heat treatment temperature is not limited. Additionally, an atmosphere for heat treatment is not limited, except that it is preferred that the atmosphere does not react with the heat treatment container.

Shape of the heat treatment container of the present invention is not particularly limited as long as the lithium-containing compound can be placed in (held by) the container. Examples of the shape include a rough shape of a plate having an upper surface which the lithium-containing compound is placed on (held by, fixed to), a shape of a tub (a tube) having an opening on a top or a side, a closed shape of a tub (a tube) which has an opening covered with a lid member (what is called a saggar). It should be noted that in the heat treatment container of the present invention, a portion not to be in contact with the lithium-containing compound can be formed of a different material.

In this case, the lithium-containing compound to be thermally treated in the heat treatment container of the present invention can be held by the heat treatment container in either a powder form or a molded body form.

### Method for Producing Container for Heat Treatment of Lithium-Containing Compound

The container for heat treatment of the lithium-containing compound of the present invention is not particularly limited in production method and can be any production method as long as it is formed of a predetermined material and has a porosity in a predetermined range.

For example, the container can be produced by mixing powders having different particle sizes (particle diameters), molding the mixed powder in a predetermined heat treatment container shape and firing the molded body. In this case, the molding and firing are performed so that the heat treatment container has a porosity in a predetermined range (10 to 30%). In addition, other steps such as a drying step can be appropriately performed.

### EXAMPLES

Hereinafter, the present invention will be specifically described by way of examples.

Plate-shaped containers for heat treatment of a lithium-containing compound were produced as examples of the present invention.

### EXAMPLES

Alumina powder, mullite powder and other additives were weighed in mass parts shown in Table 1 and mixed well.

The well mixed powder was pressed and molded into a square plate shape. This molding was performed by applying a pressure of 6 kN/cm².

Next, the molded bodies were naturally dried and then sintered (fired) by being held in an air atmosphere at 1350 deg. C. for 5 hours.

The bodies after fired were allowed to cool, thereby producing plate-shaped containers for heat treatment of a lithium-containing compound (Specimens 1 to 2).

TABLE 1

| EXAMPLES | | | |
|---|---|---|---|
| | RAW MATERIAL | SPECIMEN 1 | SPECIMEN 2 |
| MIXING RATIO | Alumina | 47.5 | 67.5 |
| (mass %) | Mullite | 40.5 | 22.5 |
| | Clay | 12.0 | 10.0 |
| | Sillimanite | 5.0 | — |
| | Binder | 0.7 | 1.7 |

Porosity, bulk specific gravity, and bending strength of the produced containers for heat treatment of the lithium-containing compound of Specimens 1 to 2 were respectively measured, and measurement results are shown in Table 2.

The measurement of porosity and bulk specific gravity was carried out by the method defined in the Japanese Industries Standards [JIS R 1614(the vacuum method)].

The measurement of bending strength was carried out by a three point bending test by using an electronic universal testing machine, CATY produced by Yonekura MFG, Co., Ltd. and setting a distance between support points to be 6 cm.

TABLE 2

| | | BULK | BENDING | COEFFICIENT | | | | |
|---|---|---|---|---|---|---|---|---|
| | POROSITY | SPECIFIC | STRENGTH | OF THERMAL | CONTENT (mass %) | | | |
| | (%) | GRAVITY | (Mpa) | EXPANSION (%) | Al2O3 | SiO2 | MgO | ZrO2 |
| SPECIMEN 1 | 19.2 | 2.73 | 22.5 | 0.584 | 77.9 | 19.0 | — | — |
| SPECIMEN 2 | 20.0 | 2.77 | 26.1 | 0.659 | 87.2 | 10.9 | — | — |
| SPECIMEN 3 | 34.1 | 2.18 | 8.8 | — | 75.9 | 21.8 | — | — |
| SPECIMEN 4 | 30.2 | 2.08 | 6.6 | 0.412 | 64.0 | 30.6 | 3.3 | — |
| SPECIMEN 5 | 33.9 | 2.01 | 7.8 | — | 34.7 | 41.8 | 4.7 | 15.7 |
| SPECIMEN 6 | 31.6 | 2.12 | 8.0 | — | 56.8 | 25.9 | 13.4 | — |

As shown in Table 2, it was confirmed that the container for heat treatment of the lithium-containing compound of Specimen 1 contained 77.9 mass % of alumina and 19.0 mass % of silica and had a porosity of 19.2%. It was also confirmed that the container for heat treatment of the lithium-containing compound of Specimen 2 contained 87.2 mass % of alumina and 10.9 mass % of silica and had a porosity of 20.0%.

### Evaluation

To evaluate the containers for heat treatment of the lithium-containing compound of the examples, a lithium-containing compound (LiNi_{1/3}Co_{1/3}Mn_{1/3}O₂-based compound) was repeatedly fired and the heat treatment containers after firing the compound were observed.

Specifically speaking, the firing and observation were carried as follows.

First, 3/2 mol % of lithium carbonate (Li₂Co₃) powder, 1/3 mol % of cobalt oxide (Co₃O₄) powder, 1 mol % of manganese dioxide (MnO₂) powder, and 1 mol % of nickel hydroxide (Ni(OH)₂) powder were weighed and well mixed, and then the mixture was molded in disk-shaped pellets. These pellets were molded to have a diameter of 18 mm and a thickness of 5 mm and weigh 4 g each.

The produced pellets were placed on surfaces of the containers for heat treatment of the lithium-containing compound of the respective specimens, and then placed in a firing furnace and fired by heating.

The firing of the pellets was carried out by increasing temperature to 1,100 deg. C. in 4 hours and, after the rise in temperature, keeping the temperature at 1,100 deg. C. for 4 hours in an air atmosphere, and then allowed to cool in the air.

After cooled, the pellets were removed from the surfaces of the containers for heat treatment of the lithium-containing compound of the respective specimens, and other new pellets (unfired ones) were placed on the surfaces and fired. Heating was performed under similar treatment conditions.

This operation of firing pellets was repeated twenty times.

A similar evaluation test was also performed on commercially available containers for heat treatment for a lithium-containing compound (Specimens 3 to 6). It should be noted that Specimens 3 to 6 had composition and properties shown together in Table 2.

A cross sectional surface of each of the specimens after firing pellets twenty times was observed.

Here, Specimen 3 was a heat treatment container formed of mullite, containing 75.9 mass % of alumina and 21.8 mass % of silica and having a porosity of 34.1%. That is to say, Specimen 3 had a high porosity when compared to Specimen 1 or 2.

Specimen 4 was a heat treatment container formed of mullite and cordierite, containing 64.0 mass % of alumina, 30.6 mass % of silica and 3.3 mass % of magnesia, and having a porosity of 30.2%. That is to say, Specimen 4 not only contained magnesia but also had a high porosity when compared to Specimen 1 or 2.

Specimen 5 was a heat treatment container formed of zirconia (ZrO₂) and cordierite, containing 34.7 mass % of alumina, 41.8 mass % of silica, 4.7 mass % of magnesia and 15.7 mass % of zirconia, and having a porosity of 33.9%. That is to say, Specimen 5 not only contained magnesia and zirconia but also had a high porosity when compared to Specimen 1 or 2.

Specimen 6 was a heat treatment container formed of spinel and cordierite, containing 56.8 mass % of alumina, 25.9 mass % of silica and 13.4 mass % of magnesia, and having a porosity of 31.6%. That is to say, Specimen 6 not only contained magnesia but also had a high porosity when compared to Specimen 1 or 2. Moreover, Specimen 6 had a considerably low alumina content.

In each of Specimens 1 and 2, penetration (infiltration, diffusion) of the lithium-containing compound was observed in a neighborhood of a portion which had been in contact with the pellets. A slight swell (a variation in volume) was also confirmed. Note that it was confirmed that a surface of each of Specimens 1 and 2 in the neighborhood of the portion which had been in contact with the pellets was maintained almost smooth. That is to say, in each of Specimens 1 and 2, penetration (and a slight change in volume caused by penetration) of the lithium-containing compound was confirmed but a product of reaction with the lithium-containing compound could not be confirmed. That is to say, it was confirmed that Specimen 1 or 2 did not have (or hardly had) reactivity with the lithium-containing compound.

In Specimen 3, penetration (infiltration, diffusion) of the lithium-containing compound was observed in a neighborhood of a portion which had been in contact with the pellets. Surface roughening and a swell (a variation in volume) were also confirmed in the portion which had been in contact with the pellets. This rough surface had a different color from those of the container and the portion penetrated by the lithium-containing compound, and it is apparent from this that the rough surface was a product of reaction with the lithium-containing compound. Moreover, this rough surface was brittle and easily came off. This rough surface (and a variation in change) was formed by a reaction between the portion which had been in contact with the pellets and the lithium-containing compound of the pellets. That is to say, it was confirmed that Specimen 3 reacted with the lithium-containing compound and yielded an easily detachable reaction product on its surface.

In each of Specimens 4 to 6, it was confirmed that a portion which had been in contact with the pellets was greatly swelled in a shape of sponge-like foam. It is apparent that this foamy portion was a product of reaction with the lithium-containing compound as in Specimen 3. It is assumed from a comparison with Specimens 1 to 3 that the product of reaction with the lithium-containing compound was a product of reaction with magnesia and zirconia. This sponge-like foamy portion was air holes in most of the volume and was particularly brittle and easily broken down so that powder came off. That is to say, it was confirmed that Specimens 4 to 6 reacted with the lithium-containing compound and yielded an easily detachable reaction product in a large amount on its surface.

Next, coefficients of thermal expansion of the containers of Specimens 1, 2 and 4 at 1000 deg. C. were measured and shown together in Table 2.

As shown in Table 2, it was confirmed that coefficient of thermal expansion was greater with a higher alumina content. Moreover, as shown in Table 2, it was confirmed that each of Specimens 1 and 2 had a considerably high bending strength when compared to Specimens 3 to 6.

That is to say, although having high coefficients of thermal expansion, the containers of Specimens 1 and 2 improved in thermal shock resistance owing to a high strength. Besides, because the containers of Specimens 1 and 2 were suppressed from reacting with the lithium-containing compound as mentioned above, the lithium-containing compound was also suppressed from being contaminated.

The containers of Specimens 1 and 2 which were the containers for heat treatment of the lithium-containing compound of the present invention were containers suppressed from reacting with the lithium-containing compound owing to being free from magnesia or the like and as a result suppressing the lithium-containing compound from being contaminated, and also suppressed from being cracked (damaged) by thermal shock.

### MODIFICATIONS OF EXAMPLES

Although the lithium-containing compound in the shape of pellets was fired by using the plate-shaped heat treatment containers in the abovementioned examples, shape of the heat treatment container and arrangement of the lithium-containing compound are not limited to these.

The heat treatment container can have a shape such as a shape of a tub (a tube) having an opening on a top or a side, a closed shape of a tub (a tube) with its opening covered with a lid member (what is called a saggar). On the other hand, the lithium-containing compound can have a powdery shape.

Particularly when the heat treatment container has a tub shape and the lithium-containing compound has a powdery shape, the abovementioned effects of the heat treatment containers of the examples can be exhibited more effectively.

Specifically speaking, when a powdery lithium-containing compound is placed inside of a tub-shaped container and fired (subjected to heat treatment), after firing, the lithium-containing compound after fired is taken out by directing an opening of the tub-shaped container downward. At this time, since peeling off attributable to a reaction product does not occur on an inner surface (a surface which has been in contact with the lithium-containing compound) of the heat treatment container, the lithium-containing compound after fired is not contaminated.

In contrast, for example, in containers having a similar shape to those of Specimen 3 to 6 as comparative examples, peeling off attributable to a reaction product occurs on surfaces which have been in contact with the lithium-containing compound. Then, when the lithium-containing compound is taken out, the reaction product is taken out simultaneously with the lithium-containing compound. That is to say, the reaction product contaminates the lithium-containing compound.

1. A container for heat treatment of a positive-electrode active material of a lithium ion battery, comprising:
based on a total mass of the container,
from 60 to 95 mass % of alumina, and
from 10 to 20 mass % of silica,
wherein,
the container is free from MgO, ZrO₂ and Li compounds,
the container has a porosity of from 10 to 30% and
the container is suitable for holding raw material powder of the positive-electrode active material of the lithium ion battery when the raw material powder is subject to the heat treatment.

2. (canceled)

3. The container of claim 1, wherein the container is formed of alumina and mullite.

4. The container of claim 1, wherein the container comprises from 70 to 90 mass % of alumina.

5. The container of claim 1, wherein the container has a porosity of from 15 to 25%.
